(19) United States
(12) Patent Application Publication
(10) Pub. No.: US 2022/0394234 A1
(43) Pub. Date: Dec. 8, 2022

(54) SYSTEM AND METHOD FOR IMPLEMENTING A VIEWER-SPECIFIC IMAGE PERCEPTION ADJUSTMENT WITHIN A DEFINED VIEW ZONE, AND VISION CORRECTION SYSTEM AND METHOD USING SAME

(71) Applicant: EVOLUTION OPTIKS LIMITED, Christ Church (BB)

(72) Inventors: Joseph Ivar Etigson, Toronto (CA); Raul MIHALI, Westport, CT (US); Jean-François JOLY, Victoria (CA)

(21) Appl. No.: 17/755,267

(22) PCT Filed: Nov. 5, 2020
(86) PCT No.: PCT/IB2020/060424

§ 371 Date: Apr. 26, 2022

Related U.S. Application Data
(60) Provisional application No. 62/932,755, filed on Nov. 8, 2019.

(51) Int. Cl. H04N 13/302; H04N 13/383; G06T 3/00

(52) U.S. Cl. CPC H04N 13/302; H04N 13/383; G06T 3/00

(57) ABSTRACT

Described are various embodiments of a digital display device comprising a light filed display operatively coupled thereto, and vision correction system and method user same. In one embodiment, a system and method are provided for implementing a viewer-specific image perception adjustment within a defined view zone (e.g. field of view zone).

### CROSS REFERENCE TO RELATED APPLICATIONS

This application the U.S. National Phase Application under 35 U.S.C. § 371 of International Application No. PCT/IB2020/060424, filed Nov. 5, 2020, which claims priority to U.S. Provisional Application No. 62/932,755 filed Nov. 8, 2019, the entire disclosure of which is hereby incorporated herein by reference.

### FIELD OF THE DISCLOSURE

The present disclosure relates to digital displays and image rendering methods therefor, and in particular, to a system and method for implementing a viewer-specific image perception adjustment within a defined view zone, and vision correction system and method using same.

### BACKGROUND

Individuals routinely wear corrective lenses to accommodate for reduced vision acuity in consuming images and/or information rendered, for example, on digital displays provided, for example, in day-to-day electronic devices such as smartphones, smart watches, electronic readers, tablets, laptop computers and the like, but also provided as part of vehicular dashboard displays and entertainment systems, to name a few examples. The use of bifocals or progressive corrective lenses is also commonplace for individuals suffering from near and far sightedness.

The operating systems of current electronic devices having graphical displays offer certain “Accessibility” features built into the software of the device to attempt to provide users with reduced vision the ability to read and view content on the electronic device. Specifically, current accessibility options include the ability to invert images, increase the image size, adjust brightness and contrast settings, bold text, view the device display only in grey, and for those with legal blindness, the use of speech technology. These techniques focus on the limited ability of software to manipulate display images through conventional image manipulation, with limited success.

Light field displays using lenslet arrays or parallax barriers have been proposed for correcting such visual aberrations. For a thorough review of Autostereoscopic or light field displays, Halle M. (Halle, M., “Autostereoscopic displays and computer graphics” ACM SIGGRAPH, 31(2), pp. 58-62, 1997) gives an overview of the various ways to build a glasses-free 3D display, including but not limited to parallax barriers, lenticular sheets, microlens arrays, holograms, and volumetric displays for example. Moreover, the reader is also directed to another article by Masia et al. (Masia B., Wetzstein G., Didyk P. and Gutierrez, “A survey on computational displays: Pushing the boundaries of optics, computation and perception”, Computer & Graphics 37 (2013), 1012-1038) which also provides a good review of computational displays, notably light field displays at section 7.2 and vision correcting light field displays at section 7.4.

An example of using light field displays to correct visual aberrations has been proposed by Pamplona et al. (PAMPLONA, V., OLIVEIRA, M., ALIAGA, D., AND RASKAR, R.2012. “Tailored displays to compensate for visual aberrations.” ACM Trans. Graph. (SIGGRAPH) 31). Unfortunately, conventional light field displays as used by Pamplona et al. are subject to a spatio-angular resolution trade-off; that is, an increased angular resolution decreases the spatial resolution. Hence, the viewer sees a sharp image but at the expense of a significantly lower resolution than that of the screen. To mitigate this effect, Huang et al. (see, HUANG, F.-C., AND BARSKY, B. 2011. A framework for aberration compensated displays. Tech. Rep. UCB/EECS-2011-162, University of California, Berkeley, December; and HUANG, F.-C., LANMAN, D., BARSKY, B. A., AND RASKAR, R. 2012. Correcting for optical aberrations using multi layer displays. ACM Trans. Graph. (SiGGRAPH Asia) 31, 6, 185:1-185:12. proposed the use of multilayer display designs together with prefiltering. The combination of prefiltering and these particular optical setups, however, significantly reduces the contrast of the resulting image.

Moreover, in U.S. Patent Application Publication No. 2016/0042501 and Fu-Chung Huang, Gordon Wetzstein, Brian A. Barsky, and Ramesh Raskar. “Eyeglasses-free Display: Towards Correcting Visual Aberrations with Computational Light Field Displays”. ACM Transaction on Graphics, xx:0, August 2014, the entire contents of each of which are hereby incorporated herein by reference, the combination of viewer-adaptive pre-filtering with off-the-shelf parallax barriers has been proposed to increase contrast and resolution, at the expense however, of computation time and power.

Another example includes the display of Wetzstein et al. (Wetzstein, G. et al., “Tensor Displays: Compressive Light Field Synthesis using Multilayer Displays with Directional Backlighting”, https://web.media.mit.edu/˜gordonw/TensorDisplays/Tensor Displays.pdf) which disclose a glass-free 3D display comprising a stack of time-multiplexed, light-attenuating layers illuminated by uniform or directional backlighting. However, the layered architecture may cause a range of artefacts including Moiré effects, color-channel crosstalk, interreflections, and dimming due to the layered color filter array. Similarly, Agus et al. (AGUS M. et al., “GPU Accelerated Direct Volume Rendering on an Interactive Light Field Display”, EUROGRAPHICS 2008, Volume 27, Number 2, 2008) disclose a GPU accelerated volume ray casting system interactively driving a multi-user light field display. The display, produced by the Holographika company, uses an array of specially arranged array of projectors and a holographic screen to provide glass-free 3D images. However, the display only provides a parallax effect in the horizontal orientation as having parallax in both vertical and horizontal orientations would be too computationally intensive. Finally, the FOVI3D company (http://on-demand.gputechconf.com/gtc/2018/pre sentation/s 8461-extreme-multi-view-rendering-for-light-field-displays.pdf) provides light field displays wherein the rendering pipeline is a replacement for OpenGL which transports a section of the 3D geometry for further processing within the display itself. This extra processing is possible because the display is integrated into a bulky table-like device.

While the above-noted references propose some light field display solutions, most suffer from one or more drawbacks which limits their commercial viability, usability and viewer experience, particularly in seeking to provide vision correction solutions, but also in providing other image perception adjustments and experiences.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a digital display device and solution that overcome some of the drawbacks of known techniques, or at least, provide a useful alternative thereto. Some aspects of the disclosure provide embodiments of such devices and solutions, such as a system and method for implementing a viewer-specific image perception adjustment within a defined or distinctly addressable view zone, and vision correction system and method using same.

In accordance with one aspect, there is provided a digital display system to automatically adjust viewer perception of an input image to be rendered thereon, the system comprising: a digital display medium comprising an array of pixels and operable to render a pixelated image accordingly; a gaze tracking apparatus operable to determine a viewer-specific gaze location on said digital display medium and thereby define a viewer's predominant field of view (FOV) zone thereon; an array of light field shaping elements (LFSE) at least partially shaping a light field emanating from said pixels; and a hardware processor communicatively linked to said digital display medium and said gaze tracking apparatus, and operable on said pixel data for selected pixels located within said predominant FOV zone to selectively output adjusted image pixel data to be rendered via said selected pixels, and a corresponding portion of said LFSE, so to produce a viewer-specific image perception adjustment within said predominant FOV zone (while in some examples rendering unadjusted image pixel data beyond said predominant FOV zone) thereby limiting viewer-specific processing of said adjusted image pixel data to said predominant FOV zone.

In one embodiment, the viewer has a reduced visual acuity, the hardware processor has operative access to a vision correction parameter at least partially defining the viewer's reduced visual acuity, and the viewer-specific image perception adjustment at least partially addresses the viewer's reduced visual acuity.

In one embodiment, the system is operable to distinctly adjust viewer perception for two or more viewers; wherein said gaze tracking apparatus is operable to determine respective viewer-specific gaze locations on said digital display medium and thereby define respective predominant FOV zones thereon; and wherein said hardware processor is distinctly operable on said pixel data for selected pixels located within said respective predominant FOV zones to selectively output adjusted image pixel data to be respectively rendered via said selected pixels, and corresponding portions of said LFSE, so to produce respective viewer-specific image perception adjustments within said respective predominant FOV zones (while in some examples rendering unadjusted image pixel data beyond said respective predominant field of view zones) thereby limiting viewer-specific processing of said adjusted image pixel data to said respective predominant FOV zones.

In one embodiment, each of the viewers has a respective reduced visual acuity, wherein said hardware processor has operative access to respective viewing correction parameters respectively at least partially defining each of the viewers' respective reduced visual acuity, and wherein said respective viewer-specific image perception adjustments are implemented as a function of said respective viewing correction parameters to respectively at least partially address each of the viewers' respective reduced visual acuity.

In one embodiment, the gaze tracking apparatus is further operable to determine respective viewer pupil locations, and wherein said respective viewer-specific image perception adjustments are respectively optimized as a function of said respective viewer pupil locations.

In one embodiment, two of said respective FOV zones overlap to define an overlap area, wherein said hardware processor operates on said pixel data for pixels within said overlap area in accordance with designated digital image perception adjustment overlap mitigation instructions.

In one embodiment, the designated digital image perception adjustment overlap mitigation instructions comprise instructions for allocating said overlap area to a first viewer FOV zone defined to encompass said overlap area.

In one embodiment, the overlap area is allocated to said first viewer FOV zone for a designated time period before being reallocated to a second viewer FOV zone.

In one embodiment, the designated digital image perception adjustment overlap mitigation instructions comprise instructions for allocating said overlap area to a selected one of said viewer FOV zones automatically selected as a function of a designated digital viewer priority ranking.

In one embodiment, the designated digital viewer priority ranking comprises at least one of a viewer-defined ranking, a visual acuity ranking, or a viewer position ranking.

In one embodiment, the designated digital image perception adjustment overlap mitigation instructions comprise instructions for applying a common image perception adjustment for each of said two respective FOV zones given said overlap.

In one embodiment, the common image perception adjustment comprises one of said respective viewer-specific image perception adjustments or a compromising image perception adjustment.

In one embodiment, the FOV zone is defined by a solid viewing angle or a combination of a horizontal viewing angle and a vertical viewing angle.

In one embodiment, the FOV zone is defined by a viewer's foveal FOV angle.

In one embodiment, the system further comprises a communication network interface operable to receive a viewer-specific image perception adjustment parameter from a viewer's communication device having said vision-specific image perception adjustment parameter stored thereon.

In one embodiment, the hardware processor is further operable to process facial recognition data acquired via said gaze tracking apparatus to digitally identify the viewer and automatically access a viewer-specific image perception adjustment parameter digitally associated with the viewer.

In accordance with another aspect, there is provided a computer-implemented method, automatically implemented by one or more digital data processors, to automatically adjust viewer perception of an input image to be rendered via a digital display system comprising an array of pixels and operable to render a pixelated image accordingly and an array of light field shaping elements (LFSE) at least partially shaping a light field emanating from said pixels, the method comprising: tracking a viewer-specific gaze location on said digital display system; identifying a subset of the pixels corresponding to a viewer's predominant field of view (FOV) zone digitally defined around said viewer-specific gaze location; computing adjusted image pixel data to be rendered via said subset of pixels so to render a viewer-specific image perception adjustment within said predominant FOV zone; and rendering said adjusted image pixel data via said subset of pixels and corresponding LFSE so to render said viewer-specific image perception adjustment within said predominant FOV zone, (while in some examples rendering unadjusted image pixel data beyond said predominant FOV zone) thereby limiting viewer-specific processing of said adjusted image pixel data to said predominant FOV zone.

In one embodiment, the viewer has a reduced visual acuity, wherein said computing comprises computing said adjusted image pixel data as a function of a vision correction parameter at least partially defining the viewer's reduced visual acuity, and wherein said viewer-specific image perception adjustment at least partially addresses the viewer's reduced visual acuity.

In one embodiment, the method is implemented to distinctly adjust viewer perception for two or more viewers; wherein said tracking comprises tracking respective viewer-specific gaze locations. wherein said identifying comprises identifying respective subsets of the pixels corresponding to respective predominant field of view (FOV) zones digitally defined around said respective viewer-specific gaze locations; wherein said computing comprises computing respectively adjusted image pixel data to be rendered via said respective subsets of pixels so to render a respective viewer-specific image perception adjustments within said respective predominant FOV zones; and wherein said rendering comprises rendering said respectively adjusted image pixel data within said respective predominant FOV zones while rendering unadjusted image pixel data beyond said respective predominant FOV zones thereby limiting viewer-specific processing of said respectively adjusted image pixel data to said predominant FOV zones.

In one embodiment, each of the viewers has a respective reduced visual acuity, wherein said computing comprises computing said respective adjusted image pixel data as a function of respective vision correction parameters respectively at least partially defining the viewers' respective reduced visual acuity, and wherein said viewer-specific image perception adjustment at least partially addresses the viewers' respective reduced visual acuity; wherein said computing hardware processor has operative access to respective viewing correction parameters respectively at least partially defining each of the viewers' respective reduced visual acuity, and wherein said respective viewer-specific image perception adjustments are implemented as a function of said respective viewing correction parameters to respectively at least partially address each of the viewers' respective reduced visual acuity.

In one embodiment, the tracking further comprises tracking respective viewer pupil locations, and wherein said respective viewer-specific image perception adjustments are respectively optimized as a function of said respective viewer pupil locations.

In one embodiment, two of said respective FOV zones overlap to define an overlap area, wherein said computing comprises computing adjusted image pixel data for pixels within said overlap area in accordance with designated digital image perception adjustment overlap mitigation instructions.

In one embodiment, the designated digital image perception adjustment overlap mitigation instructions comprise instructions for allocating said overlap area to a first viewer FOV zone defined to encompass said overlap area.

In one embodiment, the overlap area is allocated to said first viewer FOV zone for a designated time period before being reallocated to a second viewer FOV zone.

In one embodiment, the designated digital image perception adjustment overlap mitigation instructions comprise instructions for allocating said overlap area to a selected one of said viewer FOV zones automatically selected as a function of a designated digital viewer priority ranking.

In one embodiment, the designated digital image perception adjustment overlap mitigation instructions comprise instructions for applying a common image perception adjustment for each of said two respective FOV zones given said overlap.

In one embodiment, the common image perception adjustment comprises one of said respective viewer-specific image perception adjustments or a compromising image perception adjustment.

In one embodiment, the method further comprises receiving a viewer-specific image perception adjustment parameter from a viewer's communication device having said vision-specific image perception adjustment parameter stored thereon, and wherein said computing comprises computing said adjusted image pixel data as a function of said viewer-specific image perception adjustment parameter.

In one embodiment, the method further comprises digitally recognising the viewer via facial recognition data and automatically accessing a viewer-specific image perception adjustment parameter digitally associated with the viewer, and wherein said computing comprises computing said adjusted image pixel data as a function of said viewer-specific image perception adjustment parameter.

In accordance with another aspect, there is provided a computer-readable medium comprising digital instructions to be implemented by a digital data processor to automatically implement any of the above-noted methods.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of an illustrating display implementing a selective light field rendering process based on defined view zones as perceived by two users having reduced visual acuity, in accordance with one embodiment;

FIG. 2 is a process flow diagram of an illustrative ray-tracing rendering process, in accordance with one embodiment;

FIG. 3 is a process flow diagram of exemplary input constant parameters, user parameters and variables, respectively, for the ray-tracing rendering process of FIG. 2, in accordance with one embodiment;

FIGS. 4A to 4C are schematic diagrams illustrating certain process steps of FIG. 2, in accordance with one embodiment;

FIG. 5 is process flow diagram of an illustrative ray-tracing rendering process, in accordance with another embodiment;

FIG. 6 is a process flow diagram of a matching step of the process of FIG. 5, in accordance with one embodiment;

FIGS. 7A to 7D are schematic diagrams illustrating certain process steps of FIGS. 5 and 6, in accordance with one embodiment;

FIG. 8 is an exemplary diagram of a vision corrected light field pattern that, when properly projected by a light field display, produces a vision corrected rendering of the letter “Z” exhibiting reduced blurring for a viewer having reduced visual acuity, in accordance with one embodiment;

FIGS. 9A and 9B are photographs of a Snellen chart, as illustratively viewed by a viewer with reduced acuity without image correction (blurry image in FIG. 9A) and with image correction via a light field display (corrected image in FIG. 9B), in accordance with one embodiment;

FIG. 10 is a process flow diagram of a method for assigning distinctly addressable view zones derived from one or more user's field of view, in accordance with one embodiment;

FIG. 11 is a schematic diagram illustrating a distinct addressable view zone for a single user, in accordance with one embodiment;

FIGS. 12A to 12C are schematic diagrams illustrating different ways to define the selected field of view used to define a distinct addressable view zone, in accordance with one embodiment;

FIG. 13 is a schematic diagram illustrating two users each viewing a distinct addressable view zone, in accordance with one embodiment;

FIG. 14 is a process flow diagram of an iterative selective ray tracing step of the process of FIG. 10, in accordance with one embodiment; and

FIG. 15 is a schematic diagram illustrating an overlap area between two distinctly addressable view zones, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function. It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

The systems and methods described herein provide, in accordance with different embodiments, different examples of a system and method for implementing a viewer-specific image perception adjustment within a defined view zone, and vision correction system and method using same. For instance, the devices, displays and methods described herein may allow for adjustment of a user's perception of an input image within a defined view zone, for example, a (distinctly addressable) viewer-specific view zone defined, for example, on a light field display screen or medium (or like hardware) based on a predominant field of view of the viewer as directed to the rendered image on this screen. For example, in some embodiments, a viewer's gaze direction can be tracked so to identify a general gaze location on the screen or display around which a viewer-specific view zone can be defined, for instance, given a predominant field of view defined for the viewer. Accordingly, computation of pixel-related data required to implement the desired or intended image perception adjustment can be limited more or less to pixels contained within the defined view zone, whereas pixel-related data associated with other pixels beyond the defined view zones can be rendered unaltered, thus potentially reducing computation and processing loads without unduly limiting the viewer's experience.

In some examples, users who would otherwise require corrective eyewear such as glasses or contact lenses, or again bifocals, may consume images, or portions thereof contained within such defined viewer-specific view zones, produced by such devices, displays and methods in clear or improved focus without the use of such eyewear. Other light field display applications, such as 3D displays and the like, may also benefit from the solutions described herein, and thus, should be considered to fall within the general scope and nature of the present disclosure.

For example, some of the herein described embodiments provide for digital display devices, or devices encompassing such displays, for use by users having reduced visual acuity, whereby a portion of an image rendered by such devices can be dynamically processed and rendered via a light field display portion to accommodate the user's reduced visual acuity so that they may consume such image portions of the input image without the use of corrective eyewear, as would otherwise be required. As noted above, embodiments are not to be limited as such as the notions and solutions described herein may also be applied to other technologies in which a user's perception of selected features and/or image portions of an input image to be displayed can be altered or adjusted via the light field display.

Furthermore, while some embodiments may contemplate the implementation of a single (dynamically updating) viewer-specific view zone so to accommodate or provide adjusted visual perceptions within this view zone for a given viewer, other embodiments may also contemplate the implementation of two or more viewer-specific view zones. For example, distinct viewers consuming distinct or even overlapping image portions, may be accommodated or serviced by implementing distinct or respective viewer-specific visual perception adjustments in each of these view zones, whereas regions beyond these defined view zones may be rendered as they would otherwise without invoking applicable perception adjustments. Accordingly, in some embodiments, distinct viewers having distinct vision acuity characteristics, may be concurrently serviced or accommodated with respective view zones. In some such embodiments, various view zone overlap conflict mitigation rules and approaches may be applied to accommodate multiple viewers when such viewers direct their gaze or attention to a same or overlapping view zones, as described in further detail below.

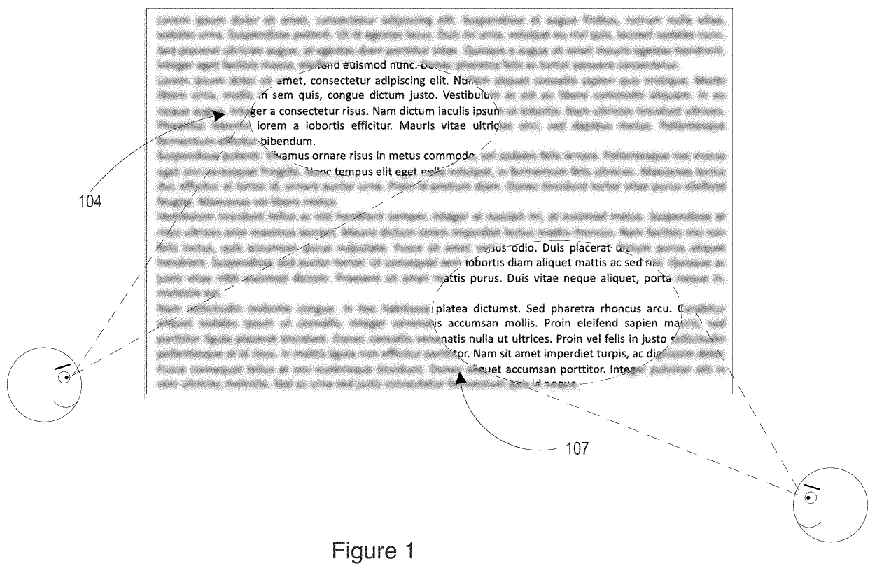

With reference to FIG. 1, and in accordance with one embodiment, an example of a light field display, such as those exemplarily described herein, is operated to selectively accommodate one or more users' reduced visual acuity by adjusting via light field only selected image portions of an input digital image using distinctly addressable view zones. For example, FIG. 1 shows an exemplary input digital image. This image, when viewed by one or more users having reduced visual acuity would be perceived as blurry. Applicant's U.S. Pat. No. 10,394,322, the entire contents of which are hereby incorporated herein by reference, teaches systems and methods for implementing vision correction using a light field display, and related technology. In the embodiments described and considered herein, a similar approach is applied so to constrain an image perception adjustment such as vision correction to a viewer-specific field of view (FOV) zone defined on the display, and/or to produce respective image perception adjustments in respective viewer-specific view zones. For example, if both viewers in FIG. 1 are viewing the image at the same time but at two distinct locations, then it is possible to distinctly define two image portions, each portion corresponding with a respective portion of each user's field of view (FOV). Thus, these distinctly addressable view zones may be used to define selected image portions 104 and 107 and to selectively render a vision corrected image tailored for each viewer's location and/or eye prescription. Therefore, the device can be operated to only provide an accurate vision correction augmentation for the selected image portions, while only providing a partial or no vision correction for the rest of the image (as will be explained below).

One possible advantage of the method described herein, according to some embodiments, is that the regions or portions of the display only seen via the user's peripheral vision, which is generally not in focus, would not have to be enhanced or corrected. This method may be especially useful, for example, with larger screens or displays that encompass an area larger than the user's central field of view. Alternatively, it may also be useful in the case where the users or viewers are physically too close to the display for it to be encompassed within their central field of view. As detailed below, these vision-corrected view zones may be defined in real-time as a result of an onboard ray tracing engine that accounts for various operational parameters such as for example, but not limited to, light field shaping element (e.g. microlens array, parallax barrier, directional or directionally modulated display light source) characteristic(s), a tracked viewer pupil location and/or gaze direction, vision correction parameter(s), etc.

In the end, methods such as those considered herein may provide viewers the ability to correctly perceive part of the input images located within a portion of the user's field of view being rendered on their devices, without necessarily requiring full corrective image processing otherwise required for full digital image correction.

For example, in some embodiments as further described below, a dynamic ray tracing process may be invoked to dynamically compute corrective pixel values required to render a corrective image portion that can accommodate a viewer's reduced visual acuity. Accordingly, by limiting the selected portion of interest, a reduced computation load may be applied to the device.

Indeed, in some embodiments, significant computational load reductions may be applied where the device can predictively output designated text-based corrections given an average relative text and/or viewer pupil location, invoking ray tracing in some instances only where significant positional/orientation changes are detected, if at all required in some embodiments and/or implementations.

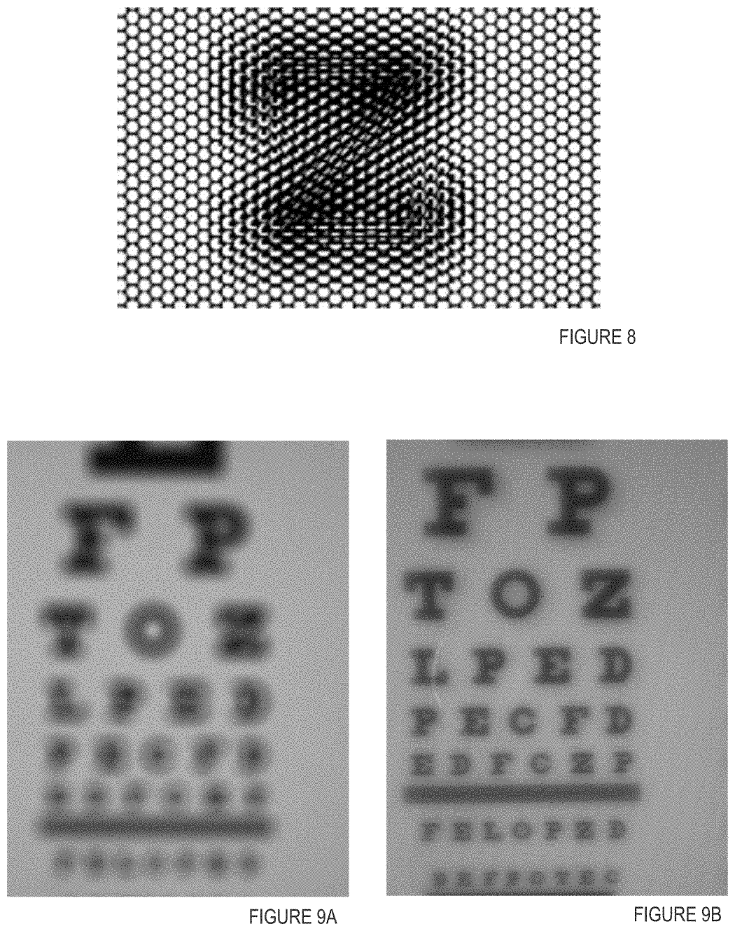

For example, upon predictably aligning a particular light field shaping element (LFSE) array, such as a microlens array, with a pixel array, a designated “circle” of pixels will correspond with each microlens and be responsible for delivering light to the pupil through that lens. In one such example, a light field display assembly comprises a microlens array that sits above an LCD display to have pixels emit light through the microlens array. A ray-tracing algorithm can thus be used to produce a pattern to be displayed on the pixel array below the microlens in order to create the desired virtual image that will effectively correct for the viewer's reduced visual acuity. FIG. 8 provides an example of such a pattern for the letter “Z”, which, when viewed through a correspondingly aligned microlens array, will produce a perceptively sharp image of this letter to a viewer having a correspondingly reduced visual acuity.

In some embodiments, light field rendering and/or eye/pupil tracking data can be centrally computed by a central processing unit of the digital display device (e.g. e-reader, tablet, smartphone or large screen processing unit), whereas in other embodiments, light field and/or eye/pupil/gaze tracking processing can be executed by a distinct vision correction processor and/or engine. In such latter embodiments, native image content or pixel data can be relayed to the light field rendering processor and display for processing. In one such latter embodiment, the vision correction hardware is detachably coupled to the native digital display device in that an extractable or otherwise complementary light field display is mechanically and/or electronically coupled to the device to cooperate therewith. In such embodiments, distinct processing resources may access data related to the selected portion via a communication interface with the native digital display device, as can various cooperative user interfaces be defined to identify and select a display portion of interest. Interfacing software or like application protocol interfaces (APIs) may be leveraged to gain access to display content (portions), notifications, etc. that are to be vision corrected. Such communicative interfaces may be hardwired through one or more digital display device ports, and/or via one or more wireless interface such as near field communication (NFC), Bluetooth™, Wi-Fi, etc.

Generally, digital light field displays as considered herein will comprise a set of image rendering pixels and an array of light field shaping elements disposed or integrated at a preset distance therefrom so to controllably shape or influence a light field emanating therefrom. Other configurations may include directional or directionally modulated display light sources, or the like. In some examples a light field shaping layer (LFSL) will be defined by an array of optical elements centered over a corresponding subset of the display's pixel array to optically influence a light field emanating therefrom and thereby govern a projection thereof from the display medium toward the user, for instance, providing some control over how each pixel or pixel group will be viewed by the viewer's eye(s). As will be further detailed below, arrayed optical elements may include, but are not limited to, lenslets, microlenses or other such diffractive optical elements that together form, for example, a lenslet array; pinholes or like apertures or windows that together form, for example, a parallax or like barrier; concentrically patterned barriers, e.g. cut outs and/or windows, such as a to define a Fresnel zone plate or optical sieve, for example, and that together form a diffractive optical barrier (as described, for example, in Applicant's co-pending U.S. application Ser. No. 15/910,908, the entire contents of which are hereby incorporated herein by reference); and/or a combination thereof, such as for example, a lenslet array whose respective lenses or lenslets are partially shadowed or barriered around a periphery thereof so to combine the refractive properties of the lenslet with some of the advantages provided by a pinhole barrier.

In operation, the display device will also generally invoke a hardware processor operable on image pixel (or subpixel) data for an image to be displayed to output corrected or adjusted image pixel data to be rendered as a function of a stored characteristic of the light field shaping elements (e.g. layer distance from display screen, distance between optical elements (pitch), absolute relative location of each pixel or subpixel to a corresponding optical element, properties of the optical elements (size, diffractive and/or refractive properties, etc.), or other such properties, and a selected vision correction or adjustment parameter related to the user's reduced visual acuity or intended viewing experience. While light field display characteristics will generally remain static for a given implementation (i.e. a given shaping layer and/or elements will be used and set for each device irrespective of the user), image processing can, in some embodiments, be dynamically adjusted as a function of the user's visual acuity or intended application so to actively adjust a distance of a virtual image plane, or perceived image on the user's retinal plane given a quantified user eye focus or like optical aberration(s), induced upon rendering the corrected/adjusted image pixel data via the static optical layer, for example, or otherwise actively adjust image processing parameters as may be considered, for example, when implementing a viewer-adaptive pre-filtering algorithm or like approach (e.g. compressive light field optimization), so to at least in part govern an image perceived by the user's eye(s) given pixel or subpixel-specific light visible thereby through the layer.

Accordingly, a given device may be adapted to compensate for different visual acuity levels and thus accommodate different users and/or uses. For instance, a particular device may be configured to implement and/or render an interactive graphical user interface (GUI) that incorporates a dynamic vision correction scaling function that dynamically adjusts one or more designated vision correction parameter(s) in real-time in response to a designated user interaction therewith via the GUI. For example, a dynamic vision correction scaling function may comprise a graphically rendered scaling function controlled by a (continuous or discrete) user slide motion or like operation, whereby the GUI can be configured to capture and translate a user's given slide motion operation to a corresponding adjustment to the designated vision correction parameter(s) scalable with a degree of the user's given slide motion operation. These and other examples are described in Applicant's co-pending U.S. patent application Ser. No. 15/246,255, the entire contents of which are hereby incorporated herein by reference.

In general, a digital display device as considered herein may include, but is not limited to, smartphones, tablets, e-readers, watches, televisions, GPS devices, laptops, desktop computer monitors, televisions, smart televisions, handheld video game consoles and controllers, vehicular dashboard and/or entertainment displays, ticketing or shopping kiosks, point-of-sale (POS) systems, workstations, digital billboard or information boards, or the like.

Generally, the device will comprise a processing unit, a digital display, and internal memory. The display can be an LCD screen, a monitor, a plasma display panel, an LED or OLED screen, or any other type of digital display defined by a set of pixels for rendering a pixelated image or other like media or information. Internal memory can be any form of electronic storage, including a disk drive, optical drive, read-only memory, random-access memory, or flash memory, to name a few examples. For illustrative purposes, memory has stored in it a vision correction or image adjustment application and/or a predictive pupil tracking engine, though various methods and techniques may be implemented to provide computer-readable code and instructions for execution by the processing unit in order to process pixel data for an image to be rendered in producing corrected pixel data amenable to producing a corrected image accommodating the user's reduced visual acuity (e.g. stored and executable image correction application, tool, utility or engine, etc.). Other components of the electronic device may optionally include, but are not limited to, one or more rear and/or front-facing camera(s) (e.g. for onboard pupil tracking capabilities), pupil tracking light source, an accelerometer and/or other device positioning/orientation devices capable of determining the tilt and/or orientation of electronic device, or the like.

For example, the electronic device, or related environment (e.g. within the context of a desktop workstation, vehicular console/dashboard, gaming or e-learning station, multimedia display room, etc.) may include further hardware, firmware and/or software components and/or modules to deliver complementary and/or cooperative features, functions and/or services. For example, as previously noted, a gaze/pupil/eye tracking system may be integrally or cooperatively implemented to improve or enhance corrective image rendering by tracking a location/gaze direction of the user's eye(s)/pupil(s) (e.g. both or one, e.g. dominant, eye(s)) and adjusting light field corrections accordingly. For instance, the device may include, integrated therein or interfacing therewith, one or more eye/pupil/gaze tracking light sources, such as one or more infrared (IR) or near-IR (NIR) light source(s) to accommodate operation in limited ambient light conditions, leverage retinal retro-reflections, invoke corneal reflection, and/or other such considerations. For instance, different IR/NIR pupil tracking techniques may employ one or more (e.g. arrayed) directed or broad illumination light sources to stimulate retinal retro-reflection and/or corneal reflection in identifying and tracking a pupil location. Other techniques may employ ambient or IR/NIR light-based machine vision and facial recognition techniques to otherwise locate and track the user's eye(s)/pupil(s). To do so, one or more corresponding (e.g. visible, IR/NIR) cameras may be deployed to capture eye/pupil tracking signals that can be processed, using various image/sensor data processing techniques, to map a 3D location of the user's eye(s)/pupil(s). In the context of a mobile device, such as a mobile phone, such eye/pupil tracking hardware/software may be integral to the device, for instance, operating in concert with integrated components such as one or more front facing camera(s), onboard IR/NIR light source(s) and the like. In other user environments, such as in a vehicular environment, eye/pupil tracking hardware may be further distributed within the environment, such as dash, console, ceiling, windshield, mirror or similarly-mounted camera(s), light sources, etc.

Furthermore, the electronic device in this example will comprise an array of light field shaping elements, such as in the form of a light field shaping layer (LFSL) overlaid or integrated atop a display medium thereof and spaced therefrom (e.g. via an integrated or distinct spacer) or other such means as may be readily apparent to the skilled artisan. For the sake of illustration, the following examples will be described within the context of a light field shaping layer defined, at least in part, by a lenslet array comprising an array of microlenses (also interchangeably referred to herein as lenslets) that are each disposed at a distance from a corresponding subset of image rendering pixels in an underlying digital display. It will be appreciated that while a light field shaping layer may be manufactured and disposed as a digital screen overlay, other integrated concepts may also be considered, for example, where light field shaping elements are integrally formed or manufactured within a digital screen's integral components such as a textured or masked glass plate, beam-shaping light sources or like component. Accordingly, each lenslet will predictively shape light emanating from these pixel subsets to at least partially govern light rays being projected toward the user by the display device. As noted above, other light field shaping layers may also be considered herein without departing from the general scope and nature of the present disclosure, whereby light field shaping will be understood by the person of ordinary skill in the art to reference measures by which light, that would otherwise emanate indiscriminately (i.e. isotropically) from each pixel group, is deliberately controlled to define predictable light rays that can be traced between the user and the device's pixels through the shaping layer.

For greater clarity, a light field is generally defined as a vector function that describes the amount of light flowing in every direction through every point in space. In other words, anything that produces or reflects light has an associated light field. The embodiments described herein produce light fields from an object that are not “natural” vector functions one would expect to observe from that object. This gives it the ability to emulate the “natural” light fields of objects that do not physically exist, such as a virtual display located far behind the light field display, which will be referred to now as the ‘virtual image’. As noted in the examples below, in some embodiments, lightfield rendering may be adjusted to effectively generate a virtual image on a virtual image plane that is set at a designated distance from an input user pupil location, for example, so to effective push back, or move forward, a perceived image relative to the display device in accommodating a user's reduced visual acuity (e.g. minimum or maximum viewing distance). In yet other embodiments, lightfield rendering may rather or alternatively seek to map the input image on a retinal plane of the user, taking into account visual aberrations, so to adaptively adjust rendering of the input image on the display device to produce the mapped effect. Namely, where the unadjusted input image would otherwise typically come into focus in front of or behind the retinal plane (and/or be subject to other optical aberrations), this approach allows to map the intended image on the retinal plane and work therefrom to address designated optical aberrations accordingly. Using this approach, the device may further computationally interpret and compute virtual image distances tending toward infinity, for example, for extreme cases of presbyopia. This approach may also more readily allow, as will be appreciated by the below description, for adaptability to other visual aberrations that may not be as readily modeled using a virtual image and image plane implementation. In both of these examples, and like embodiments, the input image is digitally mapped to an adjusted image plane (e.g. virtual image plane or retinal plane) designated to provide the user with a designated image perception adjustment that at least partially addresses designated visual aberrations. Naturally, while visual aberrations may be addressed using these approaches, other visual effects may also be implemented using similar techniques.

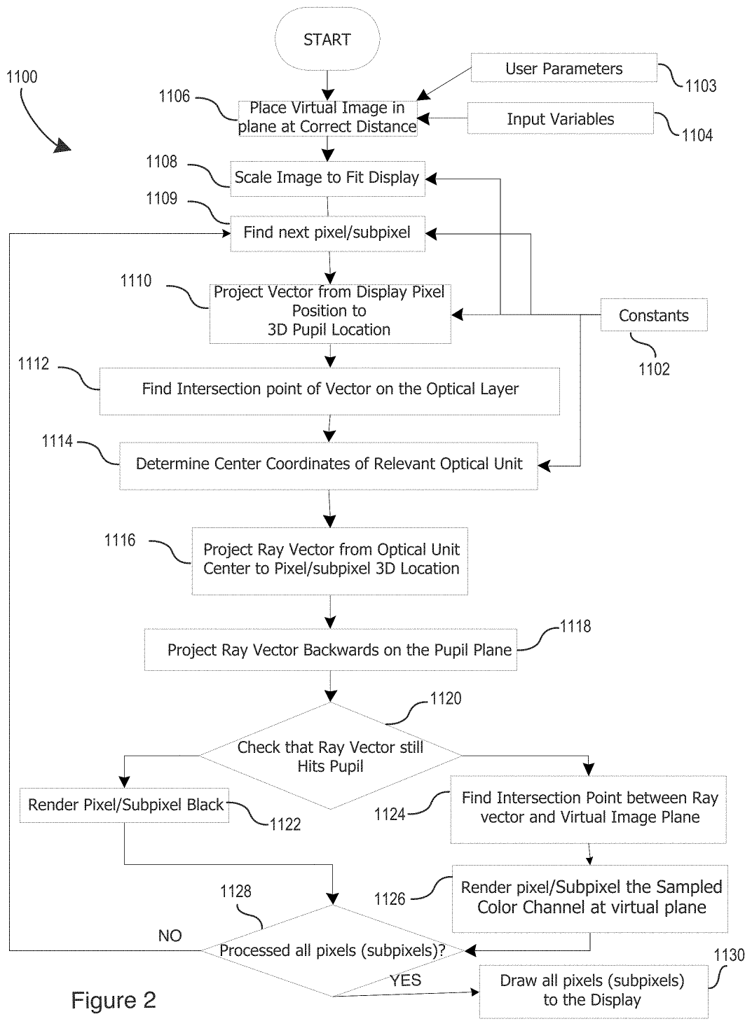

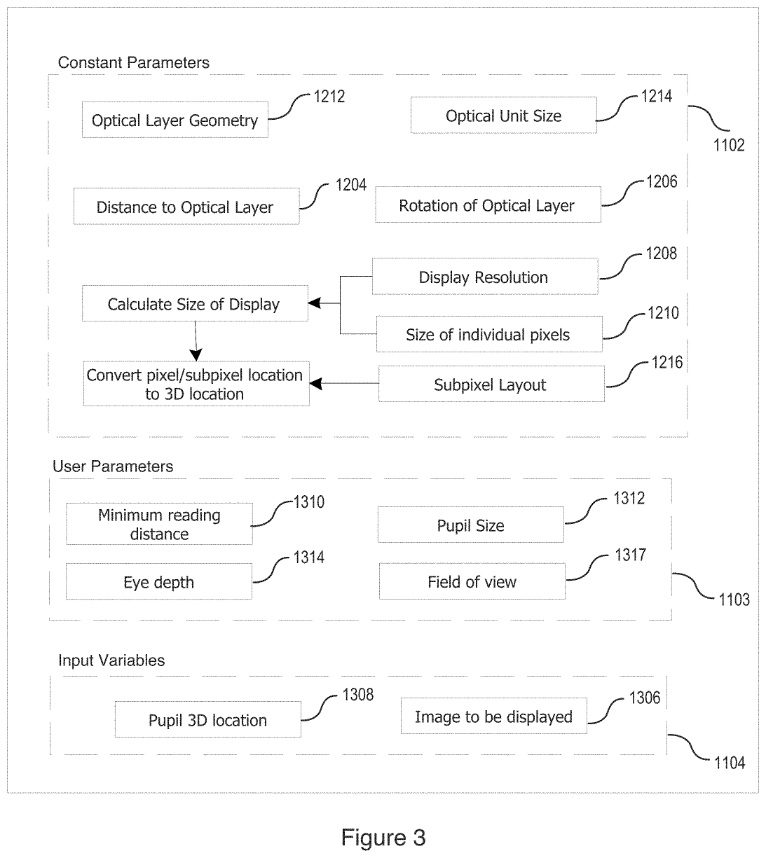

With reference to FIGS. 2 and 3, and in accordance with one embodiment, an exemplary, computationally implemented, ray-tracing method for rendering an adjusted image perception via a LFSL comprising an array of light field shaping elements (LFSE), for example a computationally corrected image that accommodates for the user's reduced visual acuity, will now be described. In this exemplary embodiment, a set of constant parameters 1102 and user parameters 1103 may be pre-determined. The constant parameters 1102 may include, for example, any data which are generally based on the physical and functional characteristics of the display (e.g. specifications, etc.) for which the method is to be implemented, as will be explained below. The user parameters 1103 may include any data that are generally linked to the user's physiology and which may change between two viewing sessions, either because different users may use the device or because some physiological characteristics have changed themselves over time. Similarly, every iteration of the rendering algorithm may use a set of input variables 1104 which are expected to change at each rendering iteration.

As illustrated in FIG. 3, the list of constant parameters 1102 may include, without limitations, the distance 1204 between the display and the LFSL, the in-plane rotation angle 1206 between the display and LFSL frames of reference, the display resolution 1208, the size of each individual pixel 1210, the optical LFSL geometry 1212, the size of each optical element 1214 within the LFSL and optionally the subpixel layout 1216 of the display. Moreover, both the display resolution 1208 and the size of each individual pixel 1210 may be used to pre-determine both the absolute size of the display in real units (i.e. in mm) and the three-dimensional position of each pixel within the display. In some embodiments where the subpixel layout 1216 is available, the position within the display of each subpixel may also be pre-determined. These three-dimensional location/positions are usually calculated using a given frame of reference located somewhere within the plane of the display, for example a corner or the middle of the display, although other reference points may be chosen. Concerning the optical layer geometry 1212, different geometries may be considered, for example a hexagonal geometry. Finally, by combining the distance 1204, the rotation angle 1206, and the geometry 1212 with the optical element size 1214, it is possible to similarly pre-determine the three-dimensional location/position of each optical element center with respect to the display's same frame of reference.

In FIG. 3, we also find an exemplary set of user parameters 1103 for method 110, which includes any data that may change between sessions or even during a session but is not expected to change in-between each iteration of the rendering algorithm. These generally comprise any data representative of the user's reduced visual acuity or condition, for example, without limitation, the minimum reading distance 1310, the eye depth 1314 and an optional pupil size 1312. In the illustrated embodiment, the minimum reading distance 1310 is defined as the minimal focus distance for reading that the user's eye(s) may be able to accommodate (i.e. able to view without discomfort). In some embodiments, different values of the minimum reading distance 1310 associated with different users may be entered, for example, as can other vision correction parameters be considered depending on the application at hand and vision correction being addressed. In some embodiments, the minimum reading distance 1310 may also change as a function of the time of day (e.g. morning vs. evening). In some embodiments, the set of user parameters 1103 may also include a field of view parameter 1317. This field of view parameter defines, as will be further discussed below, one or more angles characterizing the user's central field of view, which may exclude peripheric vision, for example, such that only pixels within or contributing to a viewer-specific view zone defined by this central field of view is accounted for or accommodated by the ray tracing process.

FIG. 3 further illustratively lists an exemplary set of input variables 1104 for method 1100, which may include any input data fed into method 1100 that is expected to change rapidly in-between different rendering iterations, and may thus include without limitation: the image(s) to be displayed 1306 (e.g. pixel data such as on/off, colour, brightness, etc.) and the three-dimensional pupil location 1308.

The image data 1306, for example, may be representative of one or more digital images to be displayed with the digital pixel display. This image may generally be encoded in any data format used to store digital images known in the art. In some embodiments, images 1306 to be displayed may change at a given framerate.

Following from the above-described embodiments, as mentioned above, a further input variable includes the three-dimensional pupil location 1308. As detailed above, the input pupil location in this sequence may include a current pupil location as output from a corresponding pupil tracking system, or a predicted pupil location, for example, when the process 1100 is implemented at a higher refresh rate than that otherwise available from the pupil tracking system, for instance. As will be appreciated by the skilled artisan, the input pupil location 1308 may be provided by an external pupil tracking engine and/or device 1305, or again provided by an internal engine and/or integrated devices, depending the application and implementation at hand. For example, a self-contained digital display device such as a mobile phone, tablet, laptop computer, digital television, or the like may include integrated hardware to provide real time pupil tracking capabilities, such as an integrated camera and machine vision-based pupil tracking engine; integrated light source, camera and glint-based pupil tracking engine; and/or a combination thereof. In other embodiments or implementations, external pupil tracking hardware and/or firmware may be leveraged to provide a real time pupil location. For example, a vehicular dashboard, control or entertainment display may interface with an external camera(s) and/or pupil tracking hardware to produce a similar effect. Naturally, the integrated or distributed nature of the various hardware, firmware and/or software components required to execute the predictive pupil tracking functionalities described herein may vary for different applications, implementations and solution at hand.

The pupil location 1308, in one embodiment, is the three-dimensional coordinates of at least one the user's pupils' center with respect to a given reference frame, for example a point on the device or display. This pupil location 1308 may be derived from any eye/pupil tracking method known in the art. In some embodiments, the pupil location 1308 may be determined prior to any new iteration of the rendering algorithm, or in other cases, at a lower framerate. In some embodiments, only the pupil location of a single user's eye may be determined, for example the user's dominant eye (i.e. the one that is primarily relied upon by the user). In some embodiments, this position, and particularly the pupil distance to the screen may otherwise or additionally be rather approximated or adjusted based on other contextual or environmental parameters, such as an average or preset user distance to the screen (e.g. typical reading distance for a given user or group of users; stored, set or adjustable driver distance in a vehicular environment; etc.).

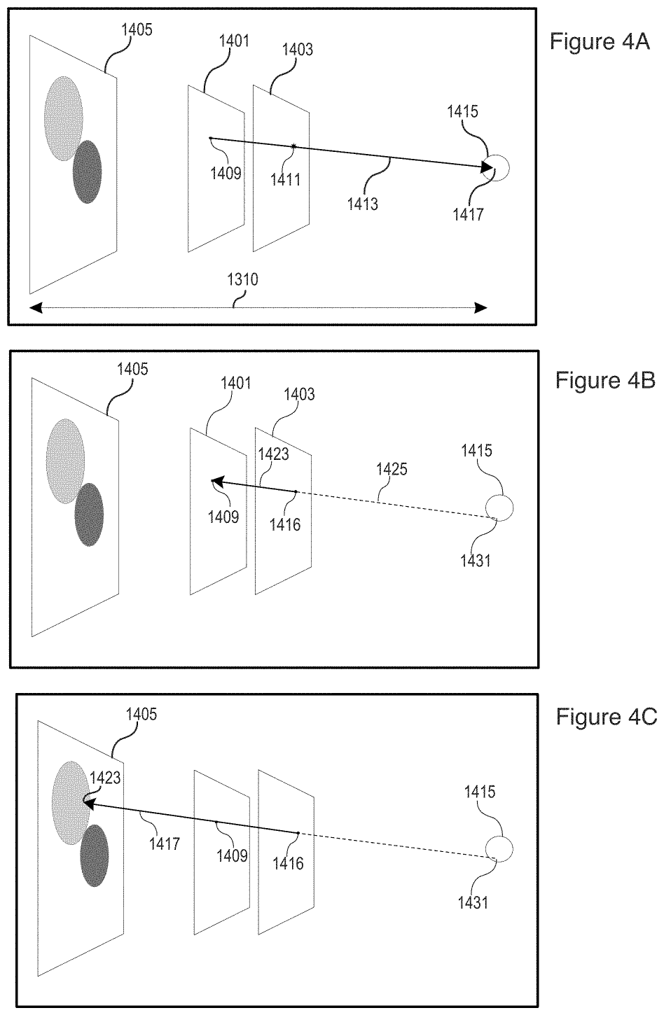

With added reference to FIGS. 4A to 4C, once constant parameters 1102, user parameters 1103, and variables 1104 have been set, the method of FIG. 2 then proceeds with step 1106, in which the minimum reading distance 1310 (and/or related parameters) is used to compute the position of a virtual (adjusted) image plane 1405 with respect to the device's display, followed by step 1108 wherein the size of image 1306 is scaled within the image plane 1405 to ensure that it correctly fills the pixel display 1401 when viewed by the distant user. This is illustrated in FIG. 4A, which shows a diagram of the relative positioning of the user's pupil 1415, the light field shaping layer 1403, the pixel display 1401 and the virtual image plane 1405. In this example, the size of image 1306 in image plane 1405 is increased to avoid having the image as perceived by the user appear smaller than the display's size.

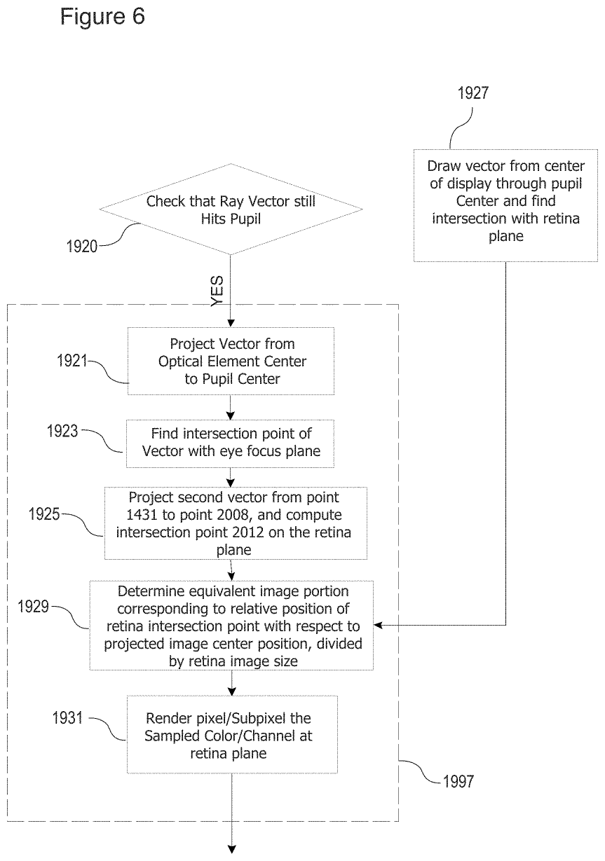

An exemplary ray-tracing methodology is described in steps 1109 to 1128 of FIG. 2, at the end of which the output color of each pixel of pixel display 1401 is known so as to virtually reproduce the light field emanating from an image 1306 positioned at the virtual image plane 1405. In FIG. 6, these steps are illustrated in a loop over each pixel in pixel display 1401, so that each of steps 1109 to 1126 describes the computations done for each individual pixel. However, in some embodiments, these computations need not be executed sequentially, but rather, steps 1109 to 1128 may be executed in parallel for each pixel or a subset of pixels at the same time. Indeed, as will be discussed below, this exemplary method is well suited to vectorization and implementation on highly parallel processing architectures such as GPUs. Moreover, note that the loop from steps 1909 to 1934 can be done on all pixels or on a subset of selected pixels only, as was described above.

As illustrated in FIG. 4A, once a new pixel for which ray-tracing is to be done is chosen at step 1109, in step 1110, for a given pixel 1409 in pixel display 1401, a trial vector 1413 is first generated from the pixel's position to the (actual or predicted) center position 1417 of pupil 1415. This is followed in step 1112 by calculating the intersection point 1411 of vector 1413 with the LFSL 1403.

The method then finds, in step 1114, the coordinates of the center 1416 of the LFSL optical element closest to intersection point 1411. Once the position of the center 1416 of the optical element is known, in step 1116, a normalized unit ray vector is generated from drawing and normalizing a vector 1423 drawn from center position 1416 to pixel 1409. This unit ray vector generally approximates the direction of the light field emanating from pixel 1409 through this particular light field element, for instance, when considering a parallax barrier aperture or lenslet array (i.e. where the path of light travelling through the center of a given lenslet is not deviated by this lenslet). Further computation may be required when addressing more complex light shaping elements, as will be appreciated by the skilled artisan. The direction of this ray vector will be used to find the portion of image 1306, and thus the associated color, represented by pixel 1409. But first, in step 1118, this ray vector is projected backwards to the plane of pupil 1415, and then in step 1120, the method verifies that the projected ray vector 1425 is still within pupil 1415 (i.e. that the user can still “see” it). Once the intersection position, for example location 1431 in FIG. 4B, of projected ray vector 1425 with the pupil plane is known, the distance between the pupil center 1417 and the intersection point 1431 may be calculated to determine if the deviation is acceptable, for example by using a pre-determined pupil size and verifying how far the projected ray vector is from the pupil center.

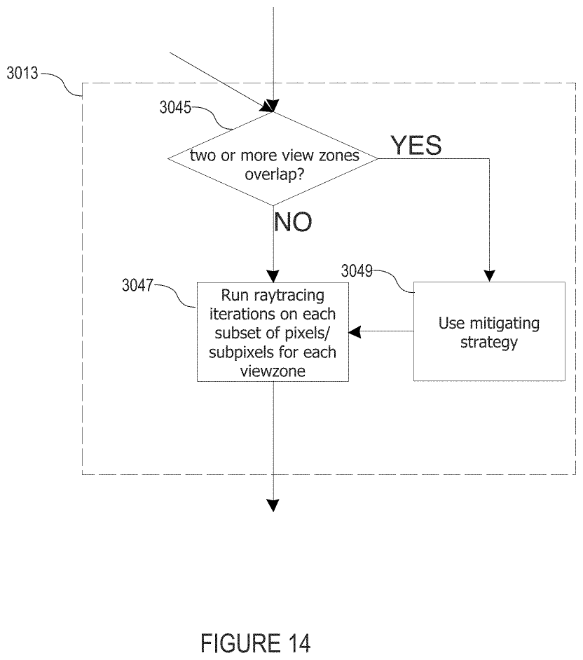

If this deviation is deemed to be too large (i.e. light emanating from pixel 1409 channeled through optical element 1416 is not perceived by pupil 1415), then in step 1122, the method flags pixel 1409 as unnecessary and to simply be turned off or render a black color. Otherwise, as shown in FIG. 14C, in step 1124, the ray vector is projected once more towards virtual image plane 1405 to find the position of the intersection point 1423 on image 1306. Then in step 1126, pixel 1409 is flagged as having the color value associated with the portion of image 1306 at intersection point 1423.

In some embodiments, method 1100 is modified so that at step 1120, instead of having a binary choice between the ray vector hitting the pupil or not, one or more smooth interpolation function (i.e. linear interpolation, Hermite interpolation or similar) are used to quantify how far or how close the intersection point 1431 is to the pupil center 1417 by outputting a corresponding continuous value between 1 or 0. For example, the assigned value is equal to 1 substantially close to pupil center 1417 and gradually change to 0 as the intersection point 1431 substantially approaches the pupil edges or beyond. In this case, the branch containing step 1122 is ignored and step 1220 continues to step 1124. At step 1126, the pixel color value assigned to pixel 1409 is chosen to be somewhere between the full color value of the portion of image 1306 at intersection point 1423 or black, depending on the value of the interpolation function used at step 1120 (1 or 0).

In yet other embodiments, pixels found to illuminate a designated area around the pupil may still be rendered, for example, to produce a buffer zone to accommodate small movements in pupil location, for example, or again, to address potential inaccuracies, misalignments or to create a better user experience.

In some embodiments, steps 1118, 1120 and 1122 may be avoided completely, the method instead going directly from step 1116 to step 1124. In such an exemplary embodiment, no check is made that the ray vector hits the pupil or not, but instead the method assumes that it always does.

Once the output colors of all pixels have been determined, these are finally rendered in step 1130 by pixel display 1401 to be viewed by the user, therefore presenting a light field corrected image. In the case of a single static image, the method may stop here. However, new input variables may be entered and the image may be refreshed at any desired frequency, for example because the user's pupil moves as a function of time and/or because instead of a single image a series of images are displayed at a given framerate.

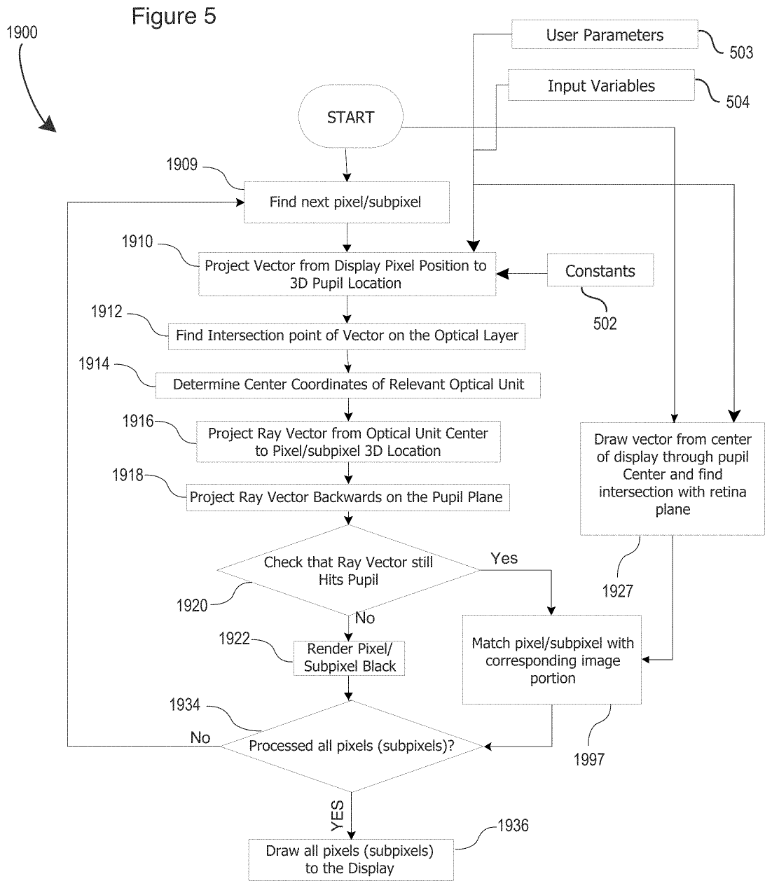

With reference to FIGS. 5, 6 and 7A to 7D, and in accordance with one embodiment, another exemplary computationally implemented ray-tracing method for rendering an adjusted image via the light field shaping layer (LFSL) that accommodates for the user's reduced visual acuity, for example, will now be described. In this embodiment, the adjusted image portion associated with a given pixel/subpixel is computed (mapped) on the retina plane instead of the virtual image plane considered in the above example, again in order to provide the user with a designated image perception adjustment. Therefore, the currently discussed exemplary embodiment shares some steps with the method of FIG. 2. Indeed, a set of constant parameters 502 may also be pre-determined. These may include, for example, any data that are generally based on the physical and functional characteristics of the display for which the method is to be implemented, as will be explained below. Similarly, user parameters 503 may also be determined which, for example, are not expected to significantly change during a user's viewing session, for instance. Finally, every iteration of the rendering algorithm may use a set of input variables 504 which are expected to change either at each rendering iteration or at least between each user viewing session. The list of possible variables and constants is substantially the same as the one disclosed in FIG. 3 and will thus not be replicated here.

Once constant parameters 502, user parameters 503, and variables 504 have been set, this second exemplary ray-tracing methodology proceeds from steps 1909 to 1936, at the end of which the output color of each pixel of the pixel display is known so as to virtually reproduce the light field emanating from an image perceived to be positioned at the correct or adjusted image distance, in one example, so to allow the user to properly focus on this adjusted image (i.e. having a focused image projected on the user's retina) despite a quantified visual aberration. In FIG. 5, these steps are illustrated in a loop over each pixel in pixel display 1401, so that each of steps 1909 to 1934 describes the computations done for each individual pixel. However, in some embodiments, these computations need not be executed sequentially, but rather, steps 1909 to 1934 may be executed in parallel for each pixel or a subset of pixels at the same time. Indeed, as will be discussed below, this second exemplary method is also well suited to vectorization and implementation on highly parallel processing architectures such as GPUs. Moreover, note that the loop from steps 1909 to 1934 can be done on all pixels or on a subset of selected pixels only, as was described above.

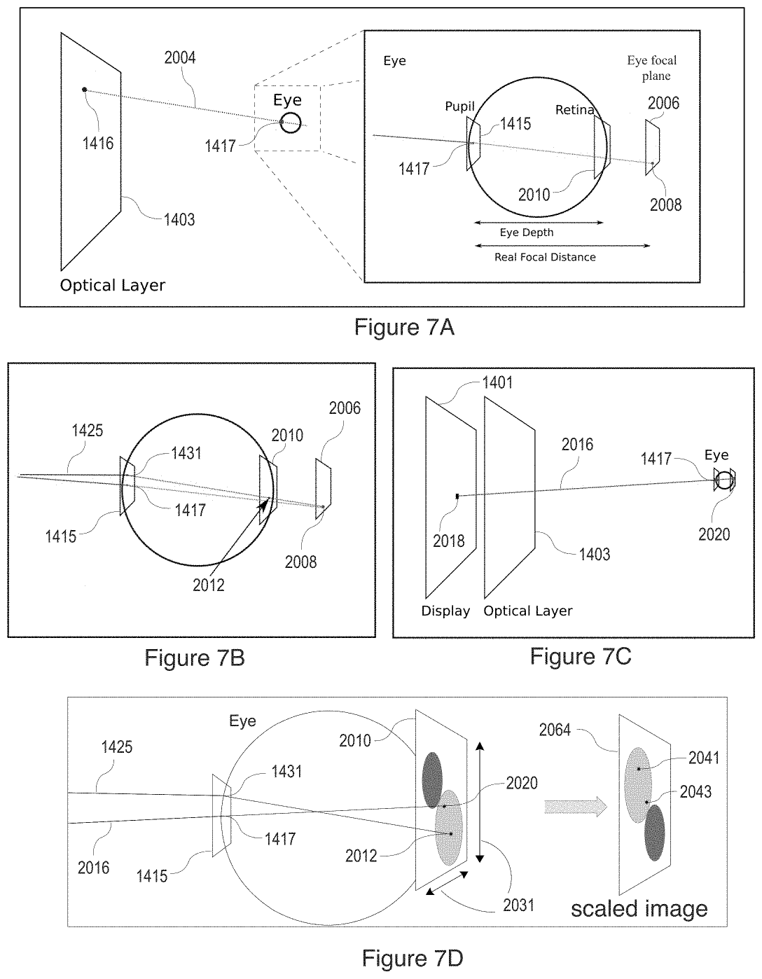

Referencing once more FIG. 7A, once a new pixel for which ray-tracing is to be done is chosen at step 1909, in step 1910 (as in step 1110), for a given pixel in pixel display 1401, a trial vector 1413 is first generated from the pixel's position to (actual or predicted) pupil center 1417 of the user's pupil 1415. This is followed in step 1912 by calculating the intersection point of vector 1413 with optical layer 1403.

From there, in step 1914, the coordinates of the optical element center 1416 closest to intersection point 1411 are determined. This step may be computationally intensive and will be discussed in more depth below. As shown in FIG. 9B, once the position of the optical element center 1416 is known, in step 1916, a normalized unit ray vector is generated from drawing and normalizing a vector 1423 drawn from optical element center 1416 to pixel 1409. This unit ray vector generally approximates the direction of the light field emanating from pixel 1409 through this particular light field element, for instance, when considering a parallax barrier aperture or lenslet array (i.e. where the path of light travelling through the center of a given lenslet is not deviated by this lenslet). Further computation may be required when addressing more complex light shaping elements, as will be appreciated by the skilled artisan. In step 1918, this ray vector is projected backwards to pupil 1415, and then in step 1920, the method ensures that the projected ray vector 1425 is still within pupil 1415 (i.e. that the user can still “see” it). Once the intersection position, for example location 1431 in FIG. 14B, of projected ray vector 1425 with the pupil plane is known, the distance between the pupil center 1417 and the intersection point 1431 may be calculated to determine if the deviation is acceptable, for example by using a pre-determined pupil size and verifying how far the projected ray vector is from the pupil center.

Now referring to FIGS. 6 and 7A to 7D, steps 1921 to 1929 of method 1900 will be described. Once optical element center 1416 of the relevant optical unit has been determined, at step 1921, a vector 2004 is drawn from optical element center 1416 to (actual or predicted) pupil center 1417. Then, in step 1923, vector 2004 is projected further behind the pupil plane onto eye focal plane 2006 (location where any light rays originating from optical layer 1403 would be focused by the eye's lens) to locate focus point 2008. For a user with perfect vision, focal plane 2006 would be located at the same location as retina plane 2010, but in this example, focal plane 2006 is located behind retina plane 2006, which would be expected for a user with some form of farsightedness. The position of focal plane 2006 may be derived from the user's minimum reading distance 1310, for example, by deriving therefrom the focal length of the user's eye. Other manually input or computationally or dynamically adjustable means may also or alternatively consider to quantify this parameter.

The skilled artisan will note that any light ray originating from optical element center 1416, no matter its orientation, will also be focused onto focus point 2008, to a first approximation. Therefore, the location on retina plane (2012) onto which light entering the pupil at intersection point 1431 will converge may be approximated by drawing a straight line between intersection point 1431 where ray vector 1425 hits the pupil 1415 and focus point 2008 on focal plane 2006. The intersection of this line with retina plane 2010 (retina image point 2012) is thus the location on the user's retina corresponding to the image portion that will be reproduced by corresponding pixel 1409 as perceived by the user. Therefore, by comparing the relative position of retina point 2012 with the overall position of the projected image on the retina plane 2010, the relevant adjusted image portion associated with pixel 1409 may be computed.

To do so, at step 1927, the corresponding projected image center position on retina plane 2010 is calculated. Vector 2016 is generated originating from the center position of display 1401 (display center position 2018) and passing through pupil center 1417. Vector 2016 is projected beyond the pupil plane onto retina plane 2010, wherein the associated intersection point gives the location of the corresponding retina image center 2020 on retina plane 2010. The skilled technician will understand that step 1927 could be performed at any moment prior to step 1929, once the relative pupil center location 1417 is known in input variables step 1904. Once image center 2020 is known, one can then find the corresponding image portion of the selected pixel/subpixel at step 1929 by calculating the x/y coordinates of retina image point 2012 relative to retina image center 2020 on the retina, scaled to the x/y retina image size 2031.

This retina image size 2031 may be computed by calculating the magnification of an individual pixel on retina plane 2010, for example, which may be approximately equal to the x or y dimension of an individual pixel multiplied by the eye depth 1314 and divided by the absolute value of the distance to the eye (i.e. the magnification of pixel image size from the eye lens). Similarly, for comparison purposes, the input image is also scaled by the image x/y dimensions to produce a corresponding scaled input image 2064. Both the scaled input image and scaled retina image should have a width and height between −0.5 to 0.5 units, enabling a direct comparison between a point on the scaled retina image 2010 and the corresponding scaled input image 2064, as shown in FIG. 20D.

From there, the image portion position 2041 relative to retina image center position 2043 in the scaled coordinates (scaled input image 2064) corresponds to the inverse (because the image on the retina is inverted) scaled coordinates of retina image point 2012 with respect to retina image center 2020. The associated color with image portion position 2041 is therefrom extracted and associated with pixel 1409.

In some embodiments, method 1900 may be modified so that at step 1920, instead of having a binary choice between the ray vector hitting the pupil or not, one or more smooth interpolation function (i.e. linear interpolation, Hermite interpolation or similar) are used to quantify how far or how close the intersection point 1431 is to the pupil center 1417 by outputting a corresponding continuous value between 1 or 0. For example, the assigned value is equal to 1 substantially close to pupil center 1417 and gradually change to 0 as the intersection point 1431 substantially approaches the pupil edges or beyond. In this case, the branch containing step 1122 is ignored and step 1920 continues to step 1124. At step 1931, the pixel color value assigned to pixel 1409 is chosen to be somewhere between the full color value of the portion of image 1306 at intersection point 1423 or black, depending on the value of the interpolation function used at step 1920 (1 or 0).

In yet other embodiments, pixels found to illuminate a designated area around the pupil may still be rendered, for example, to produce a buffer zone to accommodate small movements in pupil location, for example, or again, to address potential inaccuracies or misalignments.

Now back to FIG. 5, once the output colors of all pixels in the display have been determined (check at step 1934 is true), these are finally rendered in step 1936 by pixel display 1401 to be viewed by the user, therefore presenting a light field corrected image. In the case of a single static image, the method may stop here. However, new input variables may be entered and the image may be refreshed at any desired frequency, for example because the user's pupil moves as a function of time and/or because instead of a single image a series of images are displayed at a given framerate.

As will be appreciated by the skilled artisan, selection of the adjusted image plane onto which to map the input image in order to adjust a user perception of this input image allows for different ray tracing approaches to solving a similar challenge, that is of creating an adjusted image using the light field display that can provide an adjusted user perception, such as addressing a user's reduce visual acuity. While mapping the input image to a virtual image plane set at a designated minimum (or maximum) comfortable viewing distance can provide one solution, the alternate solution may allow accommodation of different or possibly more extreme visual aberrations. For example, where a virtual image is ideally pushed to infinity (or effectively so), computation of an infinite distance becomes problematic. However, by designating the adjusted image plane as the retinal plane, the illustrative process of FIG. 5 can accommodate the formation of a virtual image effectively set at infinity without invoking such computational challenges. Likewise, while first order focal length aberrations are illustratively described with reference to FIG. 5, higher order or other optical anomalies may be considered within the present context, whereby a desired retinal image is mapped out and traced while accounting for the user's optical aberration(s) so to compute adjusted pixel data to be rendered in producing that image. These and other such considerations should be readily apparent to the skilled artisan.

While the computations involved in the above described ray-tracing algorithms (steps 1110 to 1128 of FIG. 2 or steps 1920 to 1934 of FIGS. 5 and 6) may be done on general CPUs, it may be advantageous to use highly parallel programming schemes to speed up such computations. While in some embodiments, standard parallel programming libraries such as Message Passing Interface (MPI) or OPENMP may be used to accelerate the light field rendering via a general-purpose CPU, the light field computations described above are especially tailored to take advantage of graphical processing units (GPU), which are specifically tailored for massively parallel computations. Indeed, modern GPU chips are characterized by the very large number of processing cores, and an instruction set that is commonly optimized for graphics. In typical use, each core is dedicated to a small neighborhood of pixel values within an image, e.g., to perform processing that applies a visual effect, such as shading, fog, affine transformation, etc. GPUs are usually also optimized to accelerate exchange of image data between such processing cores and associated memory, such as RGB frame buffers. Furthermore, smartphones are increasingly being equipped with powerful GPUs to speed the rendering of complex screen displays, e.g., for gaming, video, and other image-intensive applications. Several programming frameworks and languages tailored for programming on GPUs include, but are not limited to, CUDA, OpenCL, OpenGL Shader Language (GLSL), High-Level Shader Language (HLSL) or similar. However, using GPUs efficiently may be challenging and thus require creative steps to leverage their capabilities, as will be discussed below.

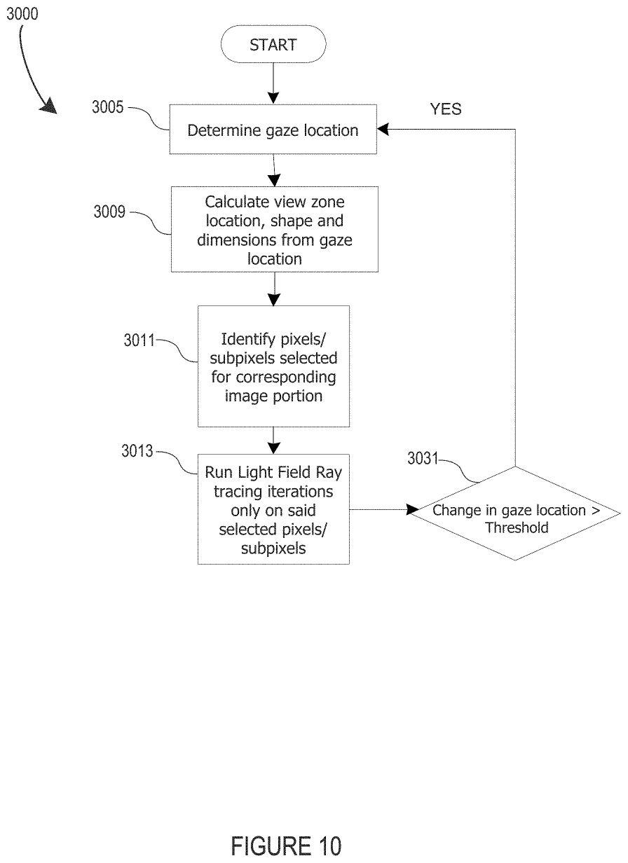

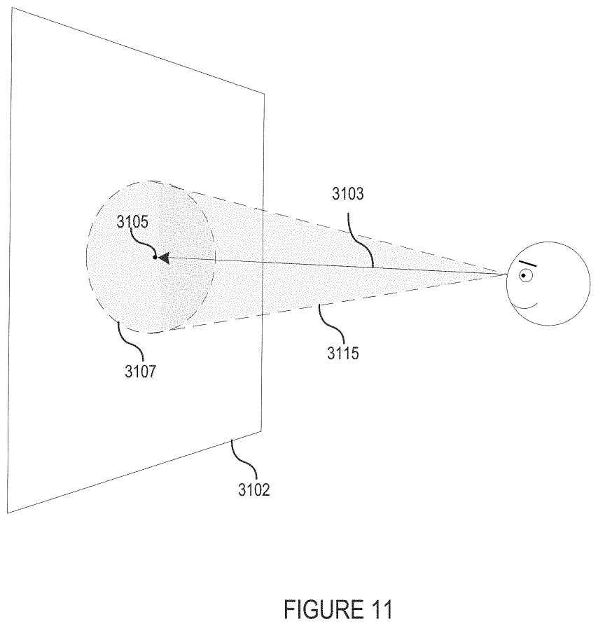

With reference to FIG. 10 and in accordance with one embodiment, a method for assigning distinctly addressable view zones derived from one or more users' field of view and selectively render a corrected image thereto via a light field display, generally referred to using the numeral 3000, will now be described. As schematically illustrated in FIG. 11, the method described herein dynamically tracks the gaze direction 3103, via an eye/gaze tracking system or apparatus, to a gaze location 3105 on a light field display 3102, which is used to define the central location of a distinctly addressable viewing zone 3107, and having a shape and size derived from considering a limited portion of field of view 3115 centered on this gaze direction. The other portions of the display may be either left unmodified, turned off, rendered all in white or black, etc. Moreover, this distinctly addressable view zone may follow the user's gaze in real-time, as the user's gaze moves from one location on the display to another, the image portions being covered by the moving view zone being corrected or enhanced accordingly.

The flow process diagram of FIG. 10 describes the steps, according to one embodiment, to dynamically track one such distinctly addressable view zone of a user. At step 3005, the gaze location 3105 on the display is determined. As mentioned above, this may be done using a gaze/pupil tracking system or apparatus and deriving the location 3105 on the display from gaze direction 3103. The gaze/eye tracking apparatus or system may be operable to detect saccadic eye movement associated with gaze shifts and detecting blinks. In some embodiments, step 3005 may be done in real-time, near real-time, or at small time intervals. In some embodiments, in step 3005, the method may wait until the gaze location has stabilized on a general vicinity before updating the viewing zone.

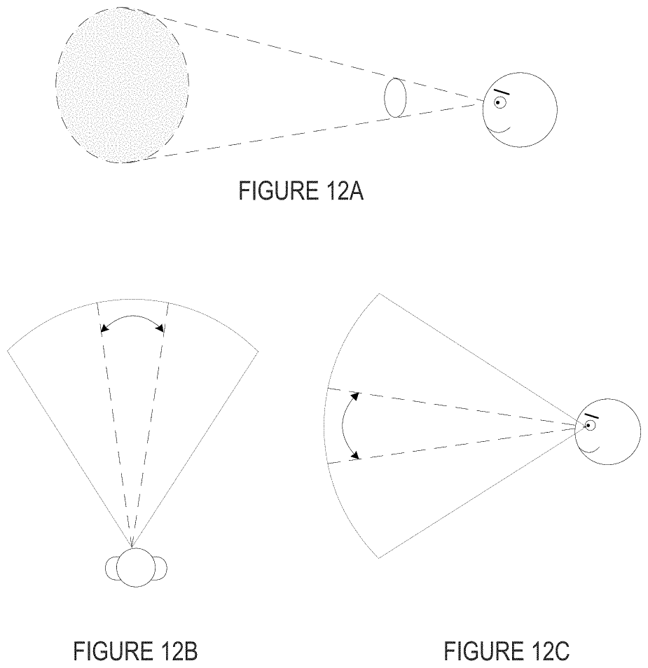

Once the gaze location 3105 is known, at step 3009, the location, shape and size of the view zone 3107 is determined. As mentioned above, view zone 3107 is centered on the gaze location 3105. The shape and size of viewing zone 3107 may be defined in terms of a selected or limited field of view. For example, if the viewing zone is restricted to a field of view roughly corresponding to the user's central vision, viewing zone 3107 would be the area on display centered on gaze location 3105 subtended or covered by the view cone 3115. The size of the selected field of view may be defined via one or more parameters. As mentioned above, these one or more field of view parameters 1317 may include a solid angle (FIG. 12A) or a combination of horizontal (FIG. 12B) and vertical (FIG. 12C) viewing angles. In some embodiments, the viewing zone portion may be restricted to vision within the central vision, for example the fovea (e.g. about 5 degrees of the visual field) or macula (about 17 degrees of the visual field), but in general any portion of the viewer's complete field of view may be used. By using both one user's pupil 3D location 1308 and a corresponding field of view 1317, the size and shape of view zone 3107 may be calculated. From that, at step 3011, the subset of pixels/subpixels being overlapped by view zone 3107 are identified.

At step 3013, at least one partial light field ray-tracing loop on selected pixels/subpixels is done on this subset of pixels/subpixels to selectively render the image portion. Then, at step 3031, the method checks if the gaze location has changed significantly (for example, by using a distance threshold or similar). If so, the method goes back to step 3005 to measure the gaze location once more and selectively update the light field display accordingly. For example, pixels identified or designated to contribute to a perceptively adjusted version of the image within this viewer-specific view zone may be considered, whereas pixel data associated with other pixels may be left unchanged.

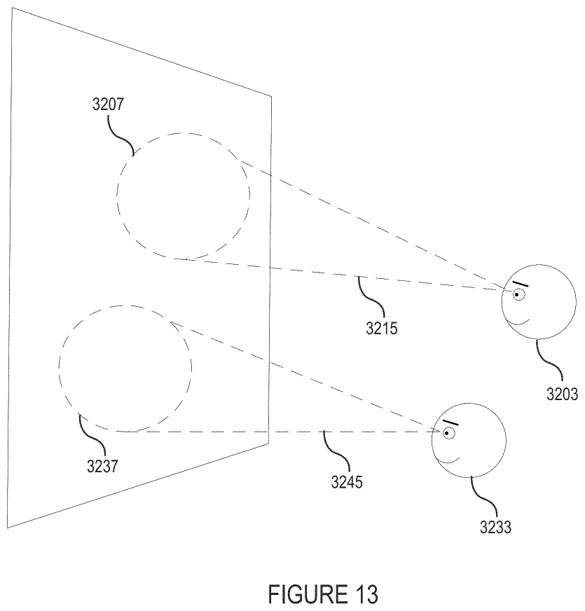

In some embodiments, method 3000 may be adapted to independently track multiple distinctly addressable view zones. Thus, the individual gaze of multiple distinct users is tracked to selectively render, for each user, a distinct addressable view zone. This is schematically illustrated in FIG. 13, where two users 3203 and 3233 each have distinct view zones 3207 and 3237, defined by their respective field of views 3215 and 3245, respectively. In this example, each user would have an image portion corresponding to their user-specific view zone corrected based on their respective location and, in some embodiments, individual eye prescription. Thus, an instance of method 3000 would be used for each user. This may be useful, for example, to implement distinctly addressable view zones for information displays or panels where different users may require information located at distinct locations on the display. In some embodiments, the gaze/pupil tracking may be combined with a face recognition system so to identify each user and automatically assign a corresponding set of vision correction parameters. In other embodiments, each user's set of vision correction parameter(s) may be transmitted via a personal digital device (e.g. a smartphone, smart key, etc.) to the light field display, for example via Bluetooth™ or NFC. In some embodiments, the system may be operable to distinguish between users, at least partially based on this wireless signal, and assign a corresponding set of vision correction parameter(s) to the correct user.

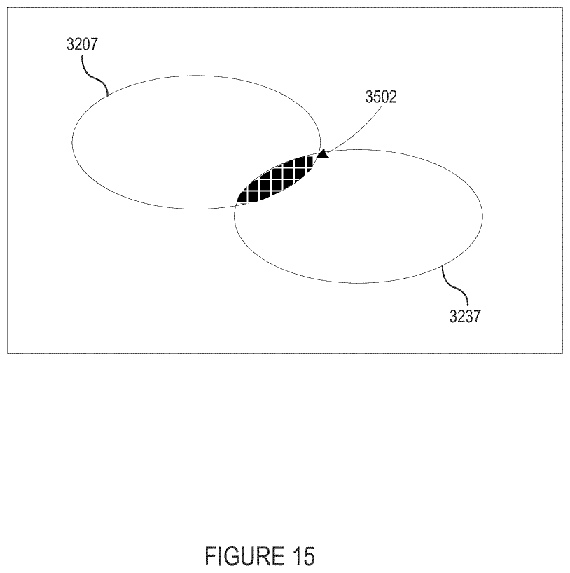

However, while steps 3005 to 3011 may be done for each user independently, step 3013 requires that every distinct image portion be rendered at the same time. An alternative version of step 3013 is presented in FIG. 14, according to one embodiment. Thus, at step 3045, the method verifies or checks if two or more viewing zones as independently determined at step 3009 are overlapping. If this is not the case, then at step 3047 each distinct associated subset of pixels/subpixels are used to render an associated image portion via a selective ray-tracing iteration, as discussed above. However, the image portion rendered via each distinct subset of pixels/subpixels is tailored for its associated user only (via at least a distinct 3D pupil location 1308 for example). If two or more viewing zones do overlap (e.g. two or more users are substantially looking at the same portion of the display), different mitigating strategies may be used at step 3049. For example, in the case where both view zones partially overlap and if that overlap area is relatively small (e.g. overlap region 3502 of view zones 3207 and 3237 as illustrated in FIG. 15), then that overlap region 3502 may be excluded from the area of both view zones 3207 and 3237. Thus, while each user would perceive a slightly reduced view zone area, this would avoid any conflict between the two set of distinct ray-tracing iterations. Other examples of mitigating strategies include giving a priority to the user already viewing the display portion (e.g. when a currently moving view zone overlaps a static view zone), thus the corresponding image portion may not be addressed for the other users until that first user looks away or goes away. In another example, a time-limit may be imposed on the first viewer, after which the image portion is enhanced for another viewer. In yet other examples, a common view zone correction may be applied to both view zones, and overlap area therebetween, for example, so to produce an equal image adjustment across both zones. The common adjustment factor may be selected, for example, based on a “worst case” viewer profile in which a highest vision correction adjustment is applied so to likely accommodate all viewers. In other examples, a “middle ground” solution may be applied whereby an average or intermediate correction is applied for both viewers. The skilled technician will understand that many mediating strategies may be employed, depending on the context, the type of image displayed, etc., and that, without departing from the general scope and nature of the present disclosure.

As detailed above, various ray-tracing implementations may be invoked, to different degrees and based on different usage scenarios, to produce geometrically accurate vision corrected, or like perception adjusted outputs, based, at least in part, as a function of a tracked pupil location. As noted above, however, some embodiments may also or alternatively at least partially rely on stored vision corrected font patterns to produce similar effects particularly, for example, where limited pupil location tracking may be required (e.g. substantially static viewing environments), where a user may naturally adjust their position and/or where the user's vision may naturally accommodate for minor geometric variations so to bypass the need for pupil tracking entirely (or at least by-pass ongoing or full fledged pupil tracking and/or ray tracing processes). These and other such implementations are intended to fall within the general scope and context of the present disclosure.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1. A digital display system to automatically adjust viewer perception of an input image to be rendered thereon, the system comprising:
a digital display medium comprising an array of pixels and operable to render a pixelated image accordingly;
a gaze tracking apparatus operable to determine a viewer-specific gaze location on said digital display medium and thereby define a viewer's predominant field of view (FOV) zone thereon;
an array of light field shaping elements (LFSE) at least partially shaping a light field emanating from said pixels; and
a hardware processor communicatively linked to said digital display medium and said gaze tracking apparatus, and operable on said pixel data for selected pixels located within said predominant FOV zone to selectively output adjusted image pixel data to be rendered via said selected pixels, and a corresponding portion of said LFSE, so to limit a viewer-specific image perception adjustment to within said predominant FOV zone thereby limiting viewer-specific processing of said adjusted image pixel data to said predominant FOV zone.

2. The system of claim 1, wherein the viewer has a reduced visual acuity, wherein said hardware processor has operative access to a vision correction parameter at least partially defining the viewer's reduced visual acuity, and wherein said viewer-specific image perception adjustment at least partially addresses the viewer's reduced visual acuity.

3. The system of claim 1:
wherein the system is operable to distinctly adjust viewer perception for two or more viewers;
wherein said gaze tracking apparatus is operable to determine respective viewer-specific gaze locations on said digital display medium and thereby define respective predominant FOV zones thereon; and
wherein said hardware processor is distinctly operable on said pixel data for selected pixels located within said respective predominant FOV zones to selectively output adjusted image pixel data to be respectively rendered via said selected pixels, and corresponding portions of said LFSE, so to limit respective viewer-specific image perception adjustments within said respective predominant FOV zones thereby limiting viewer-specific processing of said adjusted image pixel data to said respective predominant FOV zones.

4. The system of claim 3, wherein each of the viewers has a respective reduced visual acuity, wherein said hardware processor has operative access to respective viewing correction parameters respectively at least partially defining each of the viewers' respective reduced visual acuity, and wherein said respective viewer-specific image perception adjustments are implemented as a function of said respective viewing correction parameters to respectively at least partially address each of the viewers' respective reduced visual acuity.

5. The system of claim 3, wherein said gaze tracking apparatus is further operable to determine respective viewer pupil locations, and wherein said respective viewer-specific image perception adjustments are respectively optimized as a function of said respective viewer pupil locations.

6. The system of claim 3, wherein two of said respective FOV zones overlap to define an overlap area, wherein said hardware processor operates on said pixel data for pixels within said overlap area in accordance with designated digital image perception adjustment overlap mitigation instructions.

7. (canceled)

8. (canceled)

9. The system of claim 6, wherein said designated digital image perception adjustment overlap mitigation instructions comprise instructions for allocating said overlap area to a selected one of said viewer FOV zones automatically selected as a function of a designated digital viewer priority ranking.

10. The system of claim 9, wherein said designated digital viewer priority ranking comprises at least one of a viewer-defined ranking, a visual acuity ranking, or a viewer position ranking.

11. The system of claim 6, wherein said designated digital image perception adjustment overlap mitigation instructions comprise instructions for applying a common image perception adjustment for each of said two respective FOV zones given said overlap.

12. The system of claim 11, wherein said common image perception adjustment comprises one of said respective viewer-specific image perception adjustments or a compromising image perception adjustment.

13. (canceled)

14. (canceled)

15. (canceled)

16. The system of claim 1, wherein said hardware processor is further operable to process facial recognition data acquired via said gaze tracking apparatus to digitally identify the viewer and automatically access a viewer-specific image perception adjustment parameter digitally associated with the viewer.

17. A computer-implemented method, automatically implemented by one or more digital data processors, to automatically adjust viewer perception of an input image to be rendered via a digital display system comprising an array of pixels and operable to render a pixelated image accordingly and an array of light field shaping elements (LFSE) at least partially shaping a light field emanating from said pixels, the method comprising:
tracking a viewer-specific gaze location on said digital display system;
identifying a subset of the pixels corresponding to a viewer's predominant field of view (FOV) zone digitally defined around said viewer-specific gaze location;
computing adjusted image pixel data to be rendered via said subset of pixels so to render a viewer-specific image perception adjustment within said predominant FOV zone; and
rendering said adjusted image pixel data via said subset of pixels and corresponding LFSE so to render said viewer-specific image perception adjustment within said predominant FOV zone thereby limiting viewer-specific processing of said adjusted image pixel data to said predominant FOV zone.

18. The method of claim 17, wherein the viewer has a reduced visual acuity, wherein said computing comprises computing said adjusted image pixel data as a function of a vision correction parameter at least partially defining the viewer's reduced visual acuity, and wherein said viewer-specific image perception adjustment at least partially addresses the viewer's reduced visual acuity.

19. The method of claim 17:
wherein the method is implemented to distinctly adjust viewer perception for two or more viewers;
wherein said tracking comprises tracking respective viewer-specific gaze locations;
wherein said identifying comprises identifying respective subsets of the pixels corresponding to respective predominant field of view (FOV) zones digitally defined around said respective viewer-specific gaze locations;
wherein said computing comprises computing respectively adjusted image pixel data to be rendered via said respective subsets of pixels so to render a respective viewer-specific image perception adjustments within said respective predominant FOV zones; and
wherein said rendering comprises rendering said respectively adjusted image pixel data within said respective predominant FOV zones thereby limiting viewer-specific processing of said respectively adjusted image pixel data to said predominant FOV zones.

20. The method of claim 19, wherein each of the viewers has a respective reduced visual acuity, wherein said computing comprises computing said respective adjusted image pixel data as a function of respective vision correction parameters respectively at least partially defining the viewers' respective reduced visual acuity, and wherein said viewer-specific image perception adjustment at least partially addresses the viewers' respective reduced visual acuity.

21. (canceled)

22. The method of claim 19, wherein two of said respective FOV zones overlap to define an overlap area, wherein said computing comprises computing adjusted image pixel data for pixels within said overlap area in accordance with designated digital image perception adjustment overlap mitigation instructions, wherein said designated digital image perception adjustment overlap mitigation instructions comprise instructions for allocating said overlap area to a selected one of said viewer FOV zones automatically selected as a function of a designated digital viewer priority ranking.

23. (canceled)

24. (canceled)

25. (canceled)

26. The method of claim 19, wherein two of said respective FOV zones overlap to define an overlap area, wherein said computing comprises computing adjusted image pixel data for pixels within said overlap area in accordance with designated digital image perception adjustment overlap mitigation instructions, wherein said designated digital image perception adjustment overlap mitigation instructions comprise instructions for applying a common image perception adjustment for each of said two respective FOV zones given said overlap, wherein said common image perception adjustment comprises one of said respective viewer-specific image perception adjustments or a compromising image perception adjustment.

27. (canceled)

28. (canceled)

29. The method of claim 17, wherein the method further comprises digitally recognising the viewer via facial recognition data and automatically accessing a viewer-specific image perception adjustment parameter digitally associated with the viewer, and wherein said computing comprises computing said adjusted image pixel data as a function of said viewer-specific image perception adjustment parameter.

30. A computer-readable medium comprising digital instructions to be implemented by a digital data processor to automatically adjust viewer perception of an input image to be rendered via a digital display system comprising an array of pixels and operable to render a pixelated image accordingly and an array of light field shaping elements (LFSE) at least partially shaping a light field emanating from said pixels, by:
tracking a viewer-specific gaze location on said digital display system;
identifying a subset of the pixels corresponding to a viewer's predominant field of view (FOV) zone digitally defined around said viewer-specific gaze location;
computing adjusted image pixel data to be rendered via said subset of pixels so to render a viewer-specific image perception adjustment within said predominant FOV zone; and
rendering said adjusted image pixel data via said subset of pixels and corresponding LFSE so to render said viewer-specific image perception adjustment within said predominant FOV zone thereby limiting viewer-specific processing of said adjusted image pixel data to said predominant FOV zone.

31. The computer-readable medium of claim 30:
wherein said instructions are implemented to distinctly adjust viewer perception for two or more viewers;
wherein said tracking comprises tracking respective viewer-specific gaze locations;
wherein said identifying comprises identifying respective subsets of the pixels corresponding to respective predominant field of view (FOV) zones digitally defined around said respective viewer-specific gaze locations;
wherein said computing comprises computing respectively adjusted image pixel data to be rendered via said respective subsets of pixels so to render a respective viewer-specific image perception adjustments within said respective predominant FOV zones; and
wherein said rendering comprises rendering said respectively adjusted image pixel data within said respective predominant FOV zones thereby limiting viewer-specific processing of said respectively adjusted image pixel data to said predominant FOV zones.
